(19) United States
(12) Patent Application Publication
(10) Pub. No.: US 2026/0004479 A1
(43) Pub. Date: Jan. 1, 2026

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventors: Yuko NINOMIYA, Tokyo (JP); Masato Nakayama, Tokyo (JP)

(73) Assignee: FUJIFILM Corporation, Tokyo (JP)

(21) Appl. No.: 19/239,924

(22) Filed: Jun. 16, 2025

(30) Foreign Application Priority Data
Jun. 27, 2024 (JP) 2024-104180

(51) Int. Cl. G06T 11/00

(52) U.S. Cl. CPC G06T 11/003

(57) ABSTRACT

An image processing apparatus used for CT imaging in which a series of processes is performed including acquisition of a plurality of projection images using a photon-counting type radiation detector and execution of multi-reconstruction for generating tomographic images by reconstructing the plurality of projection images based on a predetermined parameter includes at least one processor, in which the processor is configured to acquire the projection image, and adjust the parameter based on the acquired projection image.

### CROSS-REFERENCE TO RELATED APPLICATION

This application claims priority from Japanese Patent Application No. 2024-104180, filed Jun. 27, 2024, the disclosure of which is incorporated herein by reference in its entirety.

### BACKGROUND OF THE INVENTION

### Technical Field

The present disclosure relates to an image processing apparatus, an image processing method, and a non-transitory computer-readable storage medium storing an image processing program.

### Related Art

As a computed tomography (CT) apparatus that captures a medical image, an energy-integrating CT (hereinafter, referred to as a photon-counting CT) using a photon-counting type radiation detector is known (see, for example, JP2012-011181A). In an examination using the photon-counting CT, as a basic operation, it is common to execute as a series of processes including scanning, multi-reconstruction, and automatic analysis under conditions set in advance in a protocol.

Incidentally, in the examination using the photon-counting CT, it is possible to reconstruct various types of images, but the reconstruction may take longer time than in the related art. This may lead to a decrease in the throughput of the entire examination.

### SUMMARY

The present disclosure has been made in consideration of the above circumstances, and an object of the present disclosure is to provide an image processing apparatus, an image processing method, and a non-transitory computer-readable storage medium storing an image processing program capable of improving the throughput of the entire examination.

In order to achieve the above object, according to a first aspect of the present disclosure, there is provided an image processing apparatus used for CT imaging in which a series of processes is performed including acquisition of a plurality of projection images using a photon-counting type radiation detector and execution of multi-reconstruction for generating tomographic images by reconstructing the plurality of projection images based on a predetermined parameter, the image processing apparatus comprising: at least one processor, in which the processor is configured to acquire the projection image, and adjust the parameter based on the acquired projection image.

According to a second aspect, in the image processing apparatus according to the first aspect, in the multi-reconstruction, a plurality of types of tomographic images are sequentially reconstructed based on the parameters that are at least partially different for each type, and the processor is configured to sequentially reconstruct the plurality of types of tomographic images using the adjusted parameters.

According to a third aspect, in the image processing apparatus according to the second aspect, the parameter is at least one of the number of the tomographic images, a range of a field of view, a thickness of the tomographic image, a matrix size, a type of the tomographic image, presence or absence of correction processing, strength of the correction processing, energy, or a window condition.

According to a fourth aspect, in the image processing apparatus according to the third aspect, the processor is configured to, in a case in which the projection image includes an image of a contrast agent or an image of a metal, set the type of the tomographic image to a virtual monochromatic X-ray image and set the energy to energy corresponding to the contrast agent or the metal.

According to a fifth aspect, in the image processing apparatus according to the fourth aspect, the processor is configured to, in a case in which it is determined that the projection image includes a calcium component, set the type of the tomographic image to a calcium-suppressed image in which the calcium component is suppressed.

According to a sixth aspect, in the image processing apparatus according to the second aspect, the processor is configured to decide an order of reconstruction according to a type of the tomographic image.

According to a seventh aspect, in the image processing apparatus according to the second aspect, the processor is configured to adjust a tomographic range for generating the tomographic image based on an image of an object of interest included in the projection image, as the parameter.

According to an eighth aspect, in the image processing apparatus according to the second aspect, the processor is configured to output the generated tomographic images to an output destination corresponding to a type of the tomographic image.

According to a ninth aspect, in the image processing apparatus according to the second aspect, the processor is configured to, in a case in which a user's designation of the parameter is received, adjust the parameter based on the designation.

According to a tenth aspect, in the image processing apparatus according to the ninth aspect, the processor is configured to display the projection image, and receive the designation performed on the projection image.

In order to achieve the above object, according to an eleventh aspect of the present disclosure, there is provided an image processing method executed by at least one processor included in an image processing apparatus used for CT imaging in which a series of processes is performed including acquisition of a plurality of projection images using a photon-counting type radiation detector and execution of multi-reconstruction for generating tomographic images by reconstructing the plurality of projection images based on a predetermined parameter, the image processing method comprising: acquiring the projection image; and adjusting the parameter based on the acquired projection image.

In order to achieve the above object, according to a twelfth aspect of the present disclosure, there is provided a non-transitory computer-readable storage medium storing an image processing program for causing at least one processor included in an image processing apparatus used for CT imaging in which a series of processes is performed including acquisition of a plurality of projection images using a photon-counting type radiation detector and execution of multi-reconstruction for generating tomographic images by reconstructing the plurality of projection images based on a predetermined parameter, to execute: acquiring the projection image; and adjusting the parameter based on the acquired projection image.

According to the present disclosure, it is possible to improve the throughput of the entire examination.

### BRIEF DESCRIPTION OF THE DRAWINGS

FIG. 1 is a configuration diagram showing an example of a configuration of a CT apparatus according to an embodiment.

FIG. 2 is a configuration diagram showing an example of a configuration of a console of the embodiment.

FIG. 3 is a functional block diagram showing an example of a function of the console of the embodiment.

FIG. 4A is a diagram for describing an example of display of a preview image.

FIG. 4B is a diagram for describing an example of display of types of parameters that can be adjusted by an adjustment unit.

FIG. 5 is a flowchart showing an example of a flow of image processing of the embodiment.

FIG. 6A is a flowchart showing an example of a flow of parameter adjustment processing related to parameter adjustment of a type and energy of an image.

FIG. 6B is a flowchart showing an example of a flow of parameter adjustment processing related to parameter adjustment of a range of a field of view (FOV).

FIG. 6C is a flowchart showing an example of a flow of parameter adjustment processing related to parameter adjustment of a type of an image in imaging using a contrast agent.

FIG. 6D is a flowchart showing an example of a flow of parameter adjustment processing related to parameter adjustment of a window condition (WW/WL).

FIG. 7 is a diagram for describing adjustment of an order of generation of tomographic images.

### DETAILED DESCRIPTION

Hereinafter, an embodiment of the present invention will be described in detail with reference to the drawings. The present embodiment does not limit the present invention.

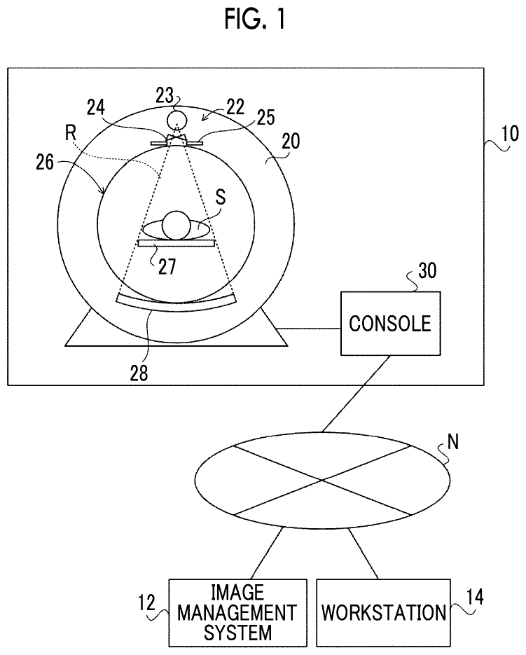

First, an example of a configuration of a computed tomography (CT) apparatus of the present embodiment will be described. FIG. 1 is a configuration diagram showing an example of a configuration of a CT apparatus 10 of the present embodiment. In CT imaging of the CT apparatus 10 of the present embodiment, a series of processes is performed, which includes acquisition of a plurality of projection images using a photon-counting type detector panel 28 and execution of multi-reconstruction for generating tomographic images by reconstructing the plurality of projection images based on a predetermined parameter. In a case in which a series of processes including the irradiation of a subject S with radiation R, the acquisition of the projection images using the detector panel 28, and the execution of the multi-reconstruction ends, an examination on the subject S ends.

As shown in FIG. 1, the CT apparatus 10 of the present embodiment comprises a gantry 20, an examination table 27, and a console 30.

The gantry 20 has an opening portion 26, and the subject S to be imaged is disposed in the opening portion 26 in a state of being placed on the examination table 27. The gantry 20 and the examination table 27 can be relatively moved in a direction penetrating the opening portion 26.

Inside the gantry 20, a radiation generation device 23 having a radiation tube (not shown), a bow tie filter 24, and a collimator 25, and the detector panel 28 are disposed in a state of facing each other across the subject S. The radiation R emitted from the radiation generation device 23 is formed into a beam shape suitable for a size of the subject S by the bow tie filter 24 and the collimator 25 and is emitted to the subject S. The detector panel 28 detects radiation transmitted through the subject S and generates a projection image according to a dose of the detected radiation. The detector panel 28 of the present embodiment is a photon-counting type detector in which a plurality of detection elements (not shown) that detect photon energy, which is energy of photons of incident radiation, are arranged in an arc shape centered on the focus of the radiation tube of the radiation generation device 23. The detector panel 28, which is a photon-counting type detector, outputs a projection image corresponding to the photon energy.

The radiation generation device 23 and the detector panel 28 are rotated around the subject S by a rotation driving unit (not shown) of the gantry 20. The radiation irradiation from the radiation generation device 23 and the radiation detection of the detector panel 28 are repeated while both the radiation generation device 23 and the detector panel 28 are rotated, thereby acquiring projection images at various projection angles. A plurality of projection images acquired by the detector panel 28 are output to the console 30.

The console 30 of the present embodiment performs various controls related to imaging, generation of a medical image, and the like. The medical image generated by the console 30 is output to an image management system 12 such as a picture archiving and communication system (PACS) or a workstation 14 via a network N. In FIG. 1, although each of the image management system 12 and the workstation 14 is illustrated one by one, the number of the image management systems 12 and the workstations 14 connected to the console 30 via the network N is not limited to one. For example, at least one of the image management system 12 or the workstation 14 may be disposed according to a medical department such as radiology or cardiothoracic surgery, or at least one of the image management system 12 or the workstation 14 may be disposed according to a person who interprets medical images.

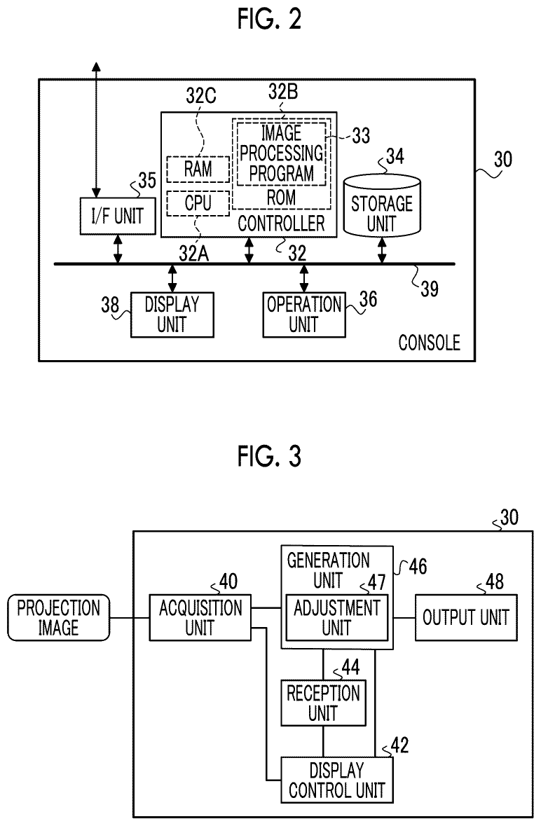

The console 30 of the present embodiment is an example of an image processing apparatus of the present disclosure. The console 30 of the present embodiment is, for example, a server computer. As shown in FIG. 2, the console 30 comprises a controller 32, a storage unit 34, an interface (I/F) unit 35, an operation unit 36, and a display unit 38. The controller 32, the storage unit 34, the I/F unit 35, the operation unit 36, and the display unit 38 are connected to each other via a bus 39 such as a system bus or a control bus so as to be able to transmit and receive various types of information.

The controller 32 of the present embodiment controls the overall operation of the console 30. The controller 32 comprises a central processing unit (CPU) 32A, a read only memory (ROM) 32B, and a random access memory (RAM) 32C. The ROM 32B stores in advance various programs including an image processing program 33 to be described below, which is executed by the CPU 32A. The RAM 32C temporarily stores various types of data.

The storage unit 34 stores the projection image output from the detector panel 28, various other types of information, and the like. Specific examples of the storage unit 34 include a storage medium such as a hard disk drive (HDD), a solid state drive (SSD), and a flash memory.

The I/F unit 35 performs communication of various types of information with the rotation driving unit (not shown) of the gantry 20, the radiation generation device 23, and the detector panel 28 through wired communication or wireless communication. The console 30 of the present embodiment receives the projection image from the detector panel 28 via the I/F unit 35. The received projection image is stored in the storage unit 34.

The console 30 acquires a plurality of projection images from the detector panel 28 via the I/F unit 35. The controller 32 performs reconstruction processing on the acquired plurality of projection images to generate tomographic images of the subject S.

In addition, the I/F unit 35 outputs the generated tomographic images to the image management system 12 and the workstation 14 via the network N through wired communication or wireless communication.

The operation unit 36 is used by a user to input various types of information such as a scan condition for acquiring the projection image, an instruction related to generation of an image such as an instruction for a parameter, and an instruction related to display of an image. The operation unit 36 is not particularly limited, and examples thereof include various switches, buttons, a touch panel, a touch pen, a keyboard, and a mouse. The display unit 38 displays various types of information, a medical image, and the like. The operation unit 36 and the display unit 38 may be integrated into a touch panel display. In addition, for example, the operation unit 36 may receive a voice input from the user.

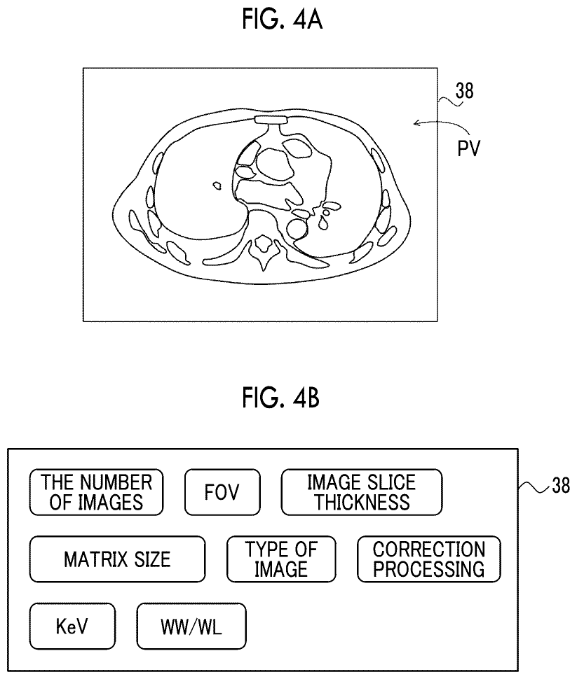

FIG. 3 shows a functional block diagram showing an example of a function of the console 30. The console 30 comprises an acquisition unit 40, a display control unit 42, a reception unit 44, a generation unit 46, and an output unit 48. As an example, the console 30 of the present embodiment executes the image processing program 33, so that the CPU 32A of the controller 32 functions as the acquisition unit 40, the display control unit 42, the reception unit 44, the generation unit 46, and the output unit 48.

The acquisition unit 40 has a function of acquiring a plurality of projection images from the detector panel 28. Specifically, as described above, the acquisition unit 40 acquires projection images captured using radiation sequentially emitted from a plurality of directions to the subject S, from the detector panel 28 via the I/F unit 35. The acquisition unit 40 may acquire a projection image that is acquired from the detector panel 28 and temporarily stored in the storage unit 34, from the storage unit 34. The acquisition unit 40 outputs the acquired projection image to the display control unit 42 and the generation unit 46.

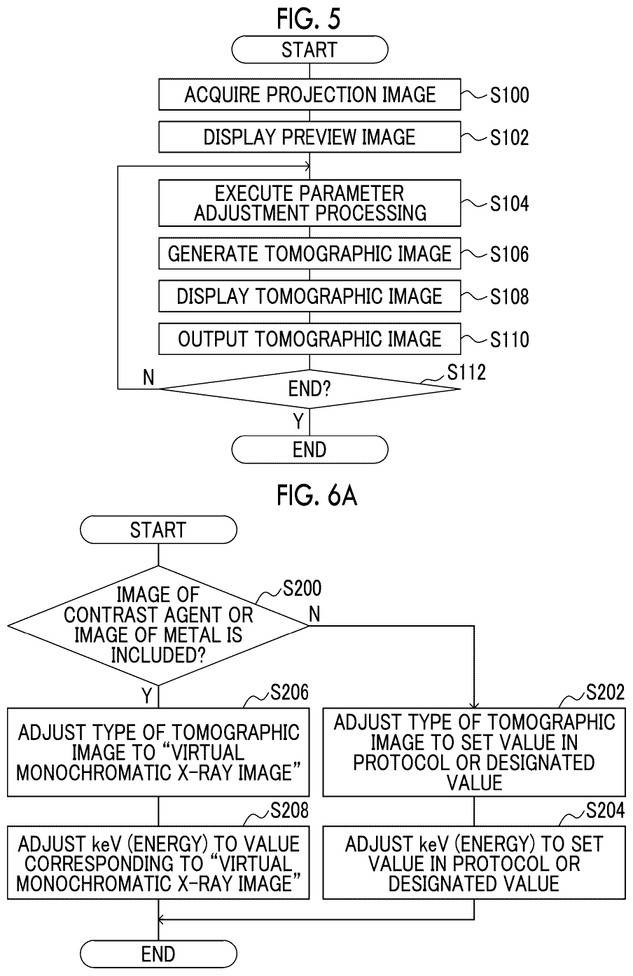

The display control unit 42 performs control of displaying the projection image acquired from the acquisition unit 40 on the display unit 38 as a preview image. FIG. 4A shows an example of a state in which a preview image PV is displayed on the display unit 38. In the present embodiment, the projection image acquired from the detector panel 28 is used as the preview image PV, and the preview image PV is a real-time image in the CT imaging. The user can use the operation unit 36 to change various parameters for the preview image PV in order to make the preview image PV easier to view. Here, the parameters that can be changed by the user for the preview image PV may be the same as or different from parameters that can be adjusted by an adjustment unit 47, for example.

In addition, the display control unit 42 performs control of displaying, on the display unit 38, information related to the parameters used for generating the tomographic images, which can be adjusted by the adjustment unit 47 of the generation unit 46. FIG. 4B shows an example of a state in which the types of the parameters that can be adjusted are displayed on the display unit 38. In the example shown in FIG. 4B, eight types of buttons of “the number of images”, “FOV”, “image slice thickness”, “matrix size”, “type of image”, “correction processing”, “keV”, and “WW/WL” are displayed corresponding to the types of the parameters that can be adjusted by the adjustment unit 47. Details thereof will be described below.

Further, the display control unit 42 of the present embodiment performs control of displaying the tomographic images generated by the generation unit 46 on the display unit 38.

The reception unit 44 receives parameter designations made by the user through the operation unit 36 for the preview image PV, which is the projection image displayed on the display unit 38, based on the display shown in FIG. 4B. The parameter designation received by the reception unit 44 is output to the generation unit 46.

The generation unit 46 generates tomographic images by reconstructing a plurality of projection images. The generation unit 46 of the present embodiment includes an adjustment unit 47 that adjusts the parameters based on the projection images. As an example, the parameters that can be adjusted by the adjustment unit 47 of the present embodiment are the number of the tomographic images, a range of a field of view, a thickness of the tomographic image, a matrix size, a type of the tomographic image, presence or absence of correction processing, strength of the correction processing, energy, and a window condition.

The term “the number of tomographic images” refers to the number of the tomographic images generated by the generation unit 46, and corresponds to “the number of images” (see FIG. 4B) displayed on the display unit 38.

The term “range of a field of view” refers to a range of an effective visual field in the image, and corresponds to the “field of view” (FOV) (see FIG. 4B) displayed on the display unit 38.

The term “thickness of the tomographic image” refers to a thickness of the tomographic image generated by the generation unit 46 (so-called slice thickness), and corresponds to the “image slice thickness” (see FIG. 4B) displayed on the display unit 38. The number of images and the image slice thickness are related to each other.

The term “matrix size” refers to a size of the entire set of pixels constituting the tomographic image generated by the generation unit 46, and is represented by the number of rows and columns of the tomographic image. The term “matrix size” corresponds to the “matrix size” (see FIG. 4B) displayed on the display unit 38.

The term “type of the tomographic image” refers to a type of tomographic image generated by the generation unit 46, and examples thereof include a virtual monochromatic X-ray image and a calcium-suppressed image. The type of the tomographic image may be a type of a commonly known tomographic image (CT image), or a unique type of tomographic image that is registered by the user designating a parameter value. The term “type of the tomographic image” corresponds to the “type of image” (see FIG. 4B) displayed on the display unit 38.

The term “presence or absence of correction processing” and the term “strength of the correction processing” refer to the presence or absence of correction processing performed on the tomographic image generated by the generation unit 46 and the strength thereof. This correspond to the “correction processing” (see FIG. 4B) displayed on the display unit 38. There may be a plurality of types of correction processing.

The term “energy” refers to an energy spectrum of the tomographic image generated by the generation unit 46. In a low-energy image, contrast is improved, so that, for example, a CT value of a contrast agent is enhanced. Conversely, in a high-energy image, the CT value of the contrast agent is weakened, but metal artifacts and the like can be reduced. The term “energy” corresponds to “keV” (see FIG. 4B) displayed on the display unit 38. In the present embodiment, the type and the energy of the tomographic image are set in conjunction with each other. That is, in a case in which one is adjusted, the other is automatically set in accordance with the adjustment.

The term “window condition” refers to a condition of a gradation to be viewed, and the window condition has an appropriate value determined depending on, for example, a part to be viewed. The term “window condition” corresponds to the “WW/WL” (see FIG. 4B) displayed on the display unit 38. “WW” (WW: Window Width) is a width of a window, and “WL” (WL: Window Level) is a level (gradation).

These parameters can be adjusted by the adjustment unit 47 based on the projection image. In addition, as described above, the user can designate the button corresponding to the type of the parameter shown in FIG. 4B by operating the operation unit 36, and, in a case in which the designation is made, the reception unit 44 receives the designation content. In this case, the adjustment unit 47 adjusts the parameter based on the designation received by the reception unit 44.

On the other hand, in a case in which the user's designation is not received, the adjustment unit 47 adjusts the parameter based on the projection image. Specifically, the adjustment unit 47 adjusts the parameter using a predetermined adjustment method, an adjustment method based on a known standard, or the like, based on an analysis result obtained by analyzing the projection image.

The generation unit 46 reconstructs the tomographic image using the parameter adjusted by the adjustment unit 47. The above parameter values have default values set in advance in a protocol, and, for parameters that have not been adjusted by the adjustment unit 47, the default values are used for reconstruction. The tomographic image generated by the generation unit 46 is output to the display control unit 42 and the output unit 48.

The output unit 48 outputs the generated tomographic image to at least one of the image management system 12 or the workstation 14, which is a designated destination. The output destination may be one or more. In addition, the designation of the output destination may be determined in advance according to the type of the tomographic image, or may be designated by the user.

Next, an action of the console 30 of the present embodiment will be described.

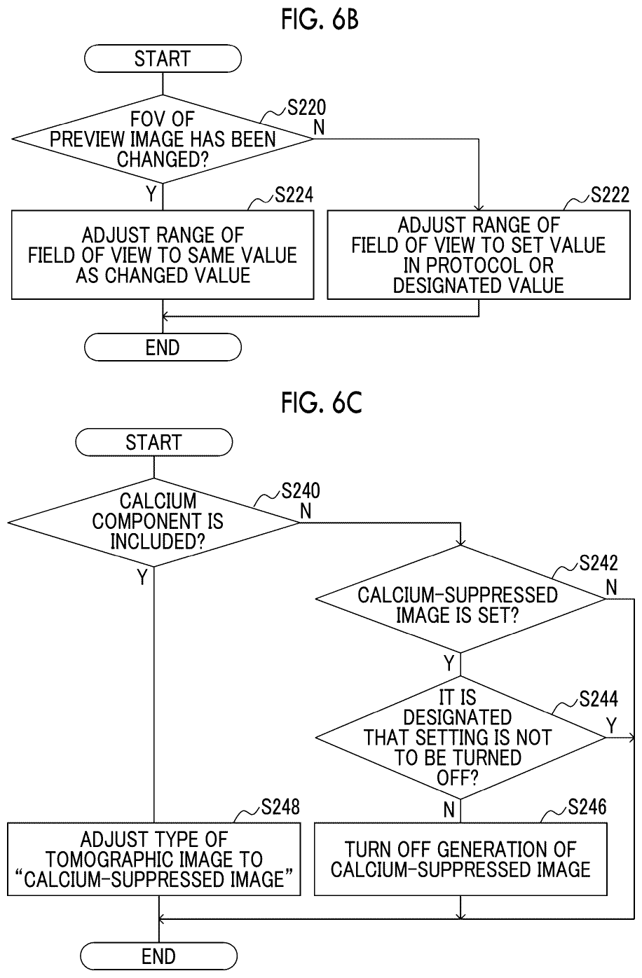

As an example, in the console 30 of the present embodiment, in a case of executing multi-reconstruction used for the CT imaging of the CT apparatus 10, the CPU 32A of the controller 32 executes the image processing program 33 stored in the ROM 32B, thereby executing image processing shown in FIG. 5 as an example. FIG. 5 is a flowchart showing an example of a flow of the image processing in the console 30 of the present embodiment.

First, in step S100 of FIG. 5, the acquisition unit 40 acquires a plurality of projection images obtained by imaging the subject S with the CT apparatus 10, as described above.

In next step S102, the display control unit 42 performs control of displaying the projection image acquired in step S100 on the display unit 38 as a preview image, as described above.

In next step S104, the adjustment unit 47 of the generation unit 46 executes the parameter adjustment processing for adjusting the parameter for the reconstruction, as described above. Details of the parameter adjustment processing will be described below.

In next step S106, the generation unit 46 generates tomographic images by reconstructing the plurality of projection images based on the parameters adjusted in step S104.

In next step S108, the display control unit 42 performs control of displaying the tomographic images generated in step S106 on the display unit 38.

In next step S110, the output unit 48 outputs the tomographic images generated in step S106 to the designated output destination, as described above. For example, the tomographic images may be output to the image management system 12 of each medical department via the workstation 14 of the radiology department. In addition, for example, in a case in which the person who interprets medical images wants to perform an analysis by himself/herself, the tomographic images may be output to the workstation 14 of the medical department to which the person who interprets medical images belongs. In addition, for example, in a case of a person who interprets medical images and acquires confirmation of an analysis result of a radiologist, the tomographic images may be output to the image management system 12 of the medical department to which the person who interprets medical images belongs. In this way, by quickly outputting the tomographic image to the designated output destination, time required for diagnosis can be shortened.

In next step S112, it is determined whether or not the generation of the tomographic image ends. For example, in a case in which another type of tomographic image is generated, the determination in step S112 is a negative determination, the process returns to step S104, and the processes of steps S104 to S110 are repeated. On the other hand, in a case in which generation of a predetermined tomographic image ends, the determination in step S112 is a positive determination, and the image processing shown in FIG. 5 ends.

Further, details of the parameter adjustment processing of step S104 of the image processing shown in FIG. 5 will be described. In the present embodiment, a plurality of types of parameter adjustment processing are provided in advance in order to adjust various parameters, and adjustment processing corresponding to the parameter to be adjusted is appropriately executed. The plurality of types of parameter adjustment processing are set in advance for each type of parameter, based on settings by the user or a combination of known parameter values.

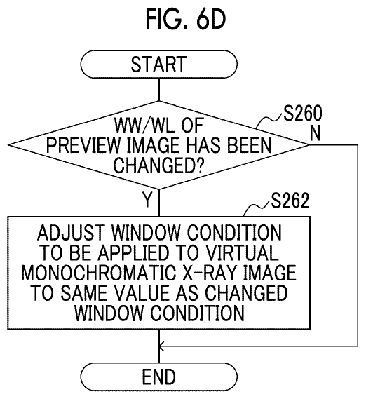

In the present embodiment, specific examples of the plurality of types of parameter adjustment processing will be described with reference to FIGS. 6A to 6D. It goes without saying that the plurality of types of parameter adjustment processing are not limited to the specific examples shown in FIGS. 6A to 6D.

FIG. 6A shows a flowchart showing an example of a flow of parameter adjustment processing related to the type and the energy of the image. In the present embodiment, as in the example shown in FIG. 6A, the type and the energy (keV) of the tomographic image are adjusted in conjunction with each other.

In step S200 of FIG. 6A, the adjustment unit 47 determines whether or not the projection image includes an image of a contrast agent or an image of a metal. The method by which the adjustment unit 47 determines whether or not the image of the contrast agent or the image of the metal is included is not limited, and a known method such as determination based on the CT value of the projection image may be applied.

In a case in which the projection image does not include the image of the contrast agent or the image of the metal, the determination in step S200 is a negative determination, and the process proceeds to step S202. In step S202, in a case in which the adjustment unit 47 adjusts the type of the tomographic image to a set value (here, the default value described above) predetermined in the protocol, or, in a case in which the user's designation is received, to the designated value.

In next step S204, in a case in which the adjustment unit 47 adjusts the energy (keV) of the tomographic image to a set value (here, the default value described above) predetermined in the protocol, or, in a case in which the user's designation is received, to the designated value. In a case where the process of step S204 ends, the parameter adjustment processing shown in FIG. 6A ends.

On the other hand, in a case in which the projection image includes the image of the contrast agent or the image of the metal, the determination in step S200 is a positive determination, and the process proceeds to step S206. In step S206, the adjustment unit 47 adjusts the type of the tomographic image to “virtual monochromatic X-ray image”.

In next step S208, the adjustment unit 47 adjusts the energy (keV) of the tomographic image to a value corresponding to the “virtual monochromatic X-ray image”. For the energy of the tomographic image, as the value corresponding to the “virtual monochromatic X-ray image”, a known value may be applied, or a value set in advance may be used. In a case in which the process of step S208 ends, the parameter adjustment processing shown in FIG. 6A ends.

FIG. 6B shows a flowchart showing an example of a flow of parameter adjustment processing related to parameter adjustment of the range of the field of view (FOV). In the present embodiment, as in the example shown in FIG. 6B, the range of the field of view (FOV) changed by the user for the preview image PV is used as the parameter of the multi-reconstruction.

In step S220 of FIG. 6B, the adjustment unit 47 determines whether or not the range of the field of view (FOV) of the preview image PV has been changed by the user.

In a case in which the range of the field of view (FOV) has not been changed, the determination in step S220 is a negative determination, and the process proceeds to step S222. In step S222, in a case in which the adjustment unit 47 adjusts the range of the field of view (FOV) to a set value (here, the default value described above) predetermined in the protocol, or, in a case in which the user's designation is received, to the designated value. In a case in which the process of step S222 ends, the parameter adjustment processing shown in FIG. 6B ends.

On the other hand, in a case in which the range of the field of view (FOV) has been changed, the determination in step S220 is a positive determination, and the process proceeds to step S224. In step S224, the adjustment unit 47 adjusts the range of the field of view (FOV) in the multi-reconstruction to the same value as the value changed for the preview image PV. In a case in which the process of step S224 ends, the parameter adjustment processing shown in FIG. 6B ends.

FIG. 6C shows a flowchart showing an example of a flow of parameter adjustment processing related to parameter adjustment of the type of the image in imaging using the contrast agent. In the present embodiment, as in the example shown in FIG. 6C, the parameter of the type of the image is adjusted depending on the presence or absence of a calcium component. The type and the energy (keV) of the tomographic image are adjusted in conjunction with each other.

In step S240 of FIG. 6C, the adjustment unit 47 determines whether or not the preview image PV includes the calcium component. The method by which the adjustment unit 47 determines whether or not the image of the calcium is included is not limited, and a known method such as determination based on the CT value of the preview image PV may be applied.

In a case in which the preview image PV does not include the calcium component, the determination in step S240 is a negative determination, and the process proceeds to step S242. In step S242, the adjustment unit 47 determines whether or not a condition for generating a calcium-suppressed image is set in the multi-reconstruction. In a case in which the condition for generating the calcium-suppressed image is not set, the determination in step S242 is a negative determination, and the parameter adjustment processing shown in FIG. 6C ends. In this case, the generation unit 46 generates the calcium-suppressed image as set in the multi-reconstruction.

On the other hand, in a case in which the condition for generating the calcium-suppressed image is set in the multi-reconstruction, the determination in step S242 is a positive determination and the process proceeds to step S244. In step S244, the adjustment unit 47 determines whether or not it is designated that the setting of the condition for generating the calcium-suppressed image is not to be turned off. In a case in which the user designates that the setting of the condition for generating the calcium-suppressed image is not to be turned off, the determination in step S244 is a positive determination, and the parameter adjustment processing shown in FIG. 6C ends. In this case, the generation unit 46 generates the calcium-suppressed image even though the preview image PV does not include the calcium component.

On the other hand, in a case in which the user does not designate that the setting of the condition for generating the calcium-suppressed image is not to be turned off, the determination in step S244 is a negative determination, and the process proceeds to step S246. In step S246, the adjustment unit 47 turns off the setting of the condition for generating the calcium-suppressed image set in the multi-reconstruction. That is, the adjustment unit 47 performs adjustment so that the calcium-suppressed image is not generated in the multi-reconstruction. In a case in which the process of step S246 ends, the parameter adjustment processing shown in FIG. 6C ends.

In addition, in a case in which the preview image PV includes the calcium component, the determination in step S240 is a positive determination, and the process proceeds to step S248. In step S248, the adjustment unit 47 adjusts the type of the tomographic image to “calcium-suppressed image”. In a case in which the process of step S248 ends, the parameter adjustment processing shown in FIG. 6C ends. In this case, as described with reference to FIG. 6A, the adjustment unit 47 adjusts the energy to energy (keV) according to the calcium-suppressed image.

FIG. 6D shows a flowchart showing an example of a flow of parameter adjustment processing related to parameter adjustment of the window condition (WW/WL). In the present embodiment, as in the example shown in FIG. 6D, the window condition (WW/WL) changed by the user for the preview image PV is used as the parameter of the multi-reconstruction.

In step S260 of FIG. 6D, the adjustment unit 47 determines whether or not the window condition (WW/WL) of the preview image PV has been changed by the user. In a case in which the window condition (WW/WL) has not been changed, the determination in step S260 is a negative determination, and the parameter adjustment processing shown in FIG. 6D ends.

On the other hand, in a case in which the window condition (WW/WL) has been changed, the determination in step S260 is a positive determination, and the process proceeds to step S262. In step S262, the adjustment unit 47 adjusts a window condition (WW/WL) to be applied to the virtual monochromatic X-ray image set in the multi-reconstruction to the same value as the window condition (WW/WL) changed for the preview image PV. The window condition (WW/WL) may be adjusted in consideration of the energy characteristic (keV) corresponding to the virtual monochromatic X-ray image instead of being adjusted to exactly the same value.

In a case in which the process of step S262 ends, the parameter adjustment processing shown in FIG. 6D ends.

The present disclosure is not limited to the above-described embodiment, and the technology of the present disclosure can be adapted to various modifications. For example, Modification Examples 1 and 2 below may be applied.

### Modification Example 1

In the above-described embodiment, a form in which the generation unit 46 uses all of the acquired projection images to generate the tomographic images that cover the entire range has been described. On the other hand, the adjustment unit 47 of the present modification example may adjust the range of the tomographic images generated by the generation unit 46. For example, the range for generating the tomographic image may be adjusted based on an image of an object of interest included in the projection image (preview image PV). Specifically, the adjustment unit 47 may perform adjustment such that a tomographic image including a cross section in which the image of the object of interest is included or only a tomographic image before and after the cross section is generated. In other words, the adjustment unit 47 may perform adjustment so as not to generate the tomographic image for a range in which the object of interest is not included. The range for generating (not generating) the tomographic image refers to at least one range of a range in a depth direction, that is, a range in a direction of a slice thickness, or a range of a cross section of the tomographic image.

As described above, by adjusting the range of the tomographic image to be generated, the range of the tomographic image generated by the generation unit 46 can be reduced, so that time required for the reconstruction can be reduced.

### Modification Example 2

In the multi-reconstruction of each of the above-described embodiments, a form in which a plurality of types of tomographic images are sequentially reconstructed by the parameters adjusted by the adjustment unit 47 based on the order predetermined in the protocol has been described. On the other hand, in the present modification example, a form in which the order of generating the tomographic images can be changed will be described. That is, in the present modification example, the order of the multi-reconstruction may be changed.

For example, the tomographic image that is important in the interpretation of medical images may be preferentially generated. That is, the tomographic image that the person who interprets medical images wants to see may be preferentially generated.

As a specific example, in a case in which the generation of a virtual monochromatic X-ray image is registered in the multi-reconstruction, the order of the generation of the virtual monochromatic X-ray image is given the highest priority, and, in a case in which the generation of a calcium-suppressed image is registered in the multi-reconstruction, the order of the generation of the calcium-suppressed image is given the highest priority. In a case in which the user designates the order, it is preferable to set the priority of the order designated by the user to be high. It is also preferable to present to the user the order in which the tomographic images are generated, that is, the order in which the multi-reconstruction is performed.

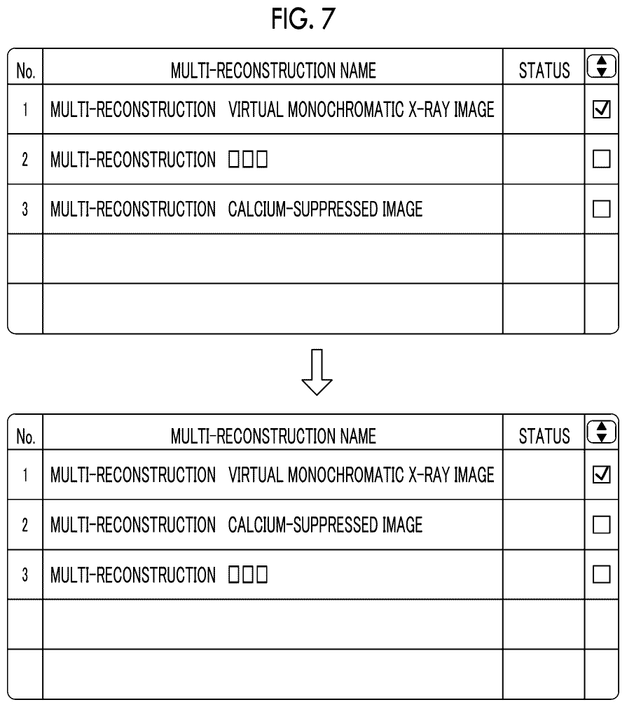

FIG. 7 shows a display example of the order of the multi-reconstruction displayed on the display unit 38 by the display control unit 42. In FIG. 7, in the multi-reconstruction protocol, a state in which the generation of three types of tomographic images is set in the order of “virtual monochromatic X-ray image”, “(represents any type of image)”, and “calcium-suppressed image” is shown. In addition, in FIG. 7, a state in which the user designates that the “virtual monochromatic X-ray image” has to be given the highest priority by checking a check box corresponding to the “virtual monochromatic X-ray image” is shown.

In a case in which it is determined that the order of the generation of the calcium-suppressed image has to be given the highest priority, the adjustment unit 47 adjusts the order so that the “virtual monochromatic X-ray image” designated by the user is the highest order (No. 1), and the “calcium-suppressed image” is generated in the next order (No. 2), as shown in an upper part of FIG. 7. That is, the adjustment unit 47 switches the second (No. 2) and third (No. 3) orders. In addition, as shown in a lower part of FIG. 7, the display control unit 42 updates the display such that the user can recognize that the orders are adjusted to be switched.

In this way, by adjusting the order of generating the tomographic images, it is possible to check the image of interest at an early timing. This makes it possible to immediately perform re-imaging, or redo the reconstruction with changed conditions, as necessary. Therefore, according to the present modification example, time required until the end of the examination can be further shortened.

As described above, the console 30 of each of the above-described embodiments is used in the CT apparatus 10 that performs a series of processes including acquisition of a plurality of projection images using the photon-counting type detector panel 28 and execution of multi-reconstruction for generating tomographic images by reconstructing the plurality of projection images based on a predetermined parameter. In the console 30, the CPU 32A functions as the acquisition unit 40 to acquire a projection image, and also functions as the adjustment unit 47 to adjust the parameters of the multi-reconstruction based on the acquired projection image.

As described above, in the console 30 of each of the above-described embodiments, the parameters of the multi-reconstruction can be optimized by using the projection image. This allows for more optimization than the parameters set in the protocol. Therefore, with the console 30 of each of the above-described embodiments, the throughput of the entire examination can be improved.

In each of the above-described embodiments, as hardware structures of processing units that execute various types of processing, such as the acquisition unit 40, the display control unit 42, the reception unit 44, the generation unit 46, and the output unit 48, various processors shown below can be used. As described above, the various processors include a programmable logic device (PLD) as a processor of which the circuit configuration can be changed after manufacture, such as a field programmable gate array (FPGA), a dedicated electrical circuit as a processor having a dedicated circuit configuration for executing specific processing such as an application specific integrated circuit (ASIC), and the like, in addition to the CPU as a general-purpose processor that functions as various processing units by executing software (program).

One processing unit may be configured of one of the various processors, or may be configured of a combination of the same or different types of two or more processors (for example, a combination of a plurality of FPGAs or a combination of the CPU and the FPGA). In addition, a plurality of processing units may be configured of one processor.

As an example in which a plurality of processing units are configured of one processor, first, as typified by a computer such as a client or a server, one processor is configured of a combination of one or more CPUs and software, and this processor functions as a plurality of processing units. Second, as typified by a system on chip (SoC) or the like, a processor that realizes the functions of the entire system including the plurality of processing units by using one integrated circuit (IC) chip is used. As described above, various processing units are configured by using one or more of the various processors as a hardware structure.

Furthermore, as the hardware structure of these various processors, more specifically, an electric circuit (circuitry) in which circuit elements such as semiconductor elements are combined can be used.

In addition, in the above-described embodiment, the aspect has been described in which the image processing program 33 is stored (installed) in the storage unit 34 of the console 30 in advance, but the present invention is not limited to this. The image processing program 33 may be provided in an aspect in which the image processing program 33 is recorded in a recording medium, such as a compact disc read only memory (CD-ROM), a digital versatile disc read only memory (DVD-ROM), and a universal serial bus (USB) memory. In addition, the image processing program 33 may be downloaded from an external device via a network.

In addition, the configurations and operations of the CT apparatus 10, the console 30, and the like described in each of the above-described embodiments are merely examples, and it is needless to say that they can be changed according to the situation without departing from the gist of the present invention. In addition, it is needless to say that the above-described embodiments may be combined as appropriate.

In addition, the present invention can also be applied to a program and a program product.

Regarding the above-described embodiments, the following appendices are further disclosed.

### Appendix 1

An image processing apparatus used for CT imaging in which a series of processes including acquisition of a plurality of projection images using a photon-counting type radiation detector and execution of multi-reconstruction for generating tomographic images by reconstructing the plurality of projection images based on a predetermined parameter is performed, the image processing apparatus comprising:
at least one processor,
in which the processor is configured to
   acquire the projection image, and
   adjust the parameter based on the acquired projection image.

### Appendix 2

The image processing apparatus according to Appendix 1,
in which, in the multi-reconstruction, a plurality of types of tomographic images are sequentially reconstructed based on the parameters that are at least partially different for each type, and
the processor is configured to sequentially reconstruct the plurality of types of tomographic images using the adjusted parameters.

### Appendix 3

The image processing apparatus according to Appendix 2,
in which the parameter is at least one of the number of the tomographic images, a range of a field of view, a thickness of the tomographic image, a matrix size, a type of the tomographic image, presence or absence of correction processing, strength of the correction processing, energy, or a window condition.

### Appendix 4

The image processing apparatus according to Appendix 3,
in which the processor is configured to, in a case in which the projection image includes an image of a contrast agent or an image of a metal, set the type of the tomographic image to a virtual monochromatic X-ray image and set the energy to energy corresponding to the contrast agent or the metal.

### Appendix 5

The image processing apparatus according to Appendix 3 or 4,
in which the processor is configured to, in a case in which it is determined that the projection image includes a calcium component, set the type of the tomographic image to a calcium-suppressed image in which the calcium component is suppressed.

### Appendix 6

The image processing apparatus according to any one of Appendices 2 to 5,
in which the processor is configured to decide an order of reconstruction according to a type of the tomographic image.

### Appendix 7

The image processing apparatus according to any one of Appendices 2 to 6,
in which the processor is configured to adjust a tomographic range for generating the tomographic image based on an image of an object of interest included in the projection image, as the parameter.

### Appendix 8

The image processing apparatus according to any one of Appendices 2 to 7,
in which the processor is configured to output the generated tomographic images to an output destination corresponding to a type of the tomographic image.

### Appendix 9

The image processing apparatus according to any one of Appendices 2 to 8,
in which the processor is configured to, in a case in which a user's designation of the parameter is received, adjust the parameter based on the designation.

### Appendix 10

The image processing apparatus according to Appendix 9,
in which the processor is configured to
   display the projection image, and
   receive the designation performed on the projection image.

### Appendix 11

An image processing method executed by at least one processor included in an image processing apparatus used for CT imaging in which a series of processes is performed including acquisition of a plurality of projection images using a photon-counting type radiation detector and execution of multi-reconstruction for generating tomographic images by reconstructing the plurality of projection images based on a predetermined parameter, the image processing method comprising:
acquiring the projection image; and
adjusting the parameter based on the acquired projection image.

### Appendix 12

An image processing program for causing at least one processor included in an image processing apparatus used for CT imaging in which a series of processes is performed including acquisition of a plurality of projection images using a photon-counting type radiation detector and execution of multi-reconstruction for generating tomographic images by reconstructing the plurality of projection images based on a predetermined parameter, to execute:
acquiring the projection image; and
adjusting the parameter based on the acquired projection image.

### Appendix 13

A computer program product including an image processing program for causing at least one processor included in an image processing apparatus used for CT imaging in which a series of processes is performed including acquisition of a plurality of projection images using a photon-counting type radiation detector and execution of multi-reconstruction for generating tomographic images by reconstructing the plurality of projection images based on a predetermined parameter, to execute:
acquiring the projection image; and
adjusting the parameter based on the acquired projection image.

### Appendix 14

A storage medium readable by a computer storing an image processing program for causing at least one processor included in an image processing apparatus used for CT imaging in which a series of processes is performed including acquisition of a plurality of projection images using a photon-counting type radiation detector and execution of multi-reconstruction for generating tomographic images by reconstructing the plurality of projection images based on a predetermined parameter, to execute:
acquiring the projection image; and
adjusting the parameter based on the acquired projection image.

What is claimed is:

1. An image processing apparatus used for CT imaging in which a series of processes including acquisition of a plurality of projection images using a photon-counting type radiation detector and execution of multi-reconstruction for generating tomographic images by reconstructing the plurality of projection images based on a predetermined parameter is performed, the image processing apparatus comprising:
at least one processor,
wherein the processor is configured to
acquire the projection image, and
adjust the parameter based on the acquired projection image.

2. The image processing apparatus according to claim 1,
wherein, in the multi-reconstruction, a plurality of types of tomographic images are sequentially reconstructed based on the parameters that are at least partially different for each type, and
the processor is configured to sequentially reconstruct the plurality of types of tomographic images using the adjusted parameters.

3. The image processing apparatus according to claim 2,
wherein the parameter is at least one of the number of the tomographic images, a range of a field of view, a thickness of the tomographic image, a matrix size, a type of the tomographic image, presence or absence of correction processing, strength of the correction processing, energy, or a window condition.

4. The image processing apparatus according to claim 3,
wherein the processor is configured to, in a case in which the projection image includes an image of a contrast agent or an image of a metal, set the type of the tomographic image to a virtual monochromatic X-ray image and set the energy to energy corresponding to the contrast agent or the metal.

5. The image processing apparatus according to claim 4,
wherein the processor is configured to, in a case in which it is determined that the projection image includes a calcium component, set the type of the tomographic image to a calcium-suppressed image in which the calcium component is suppressed.

6. The image processing apparatus according to claim 2,
wherein the processor is configured to decide an order of reconstruction according to a type of the tomographic image.

7. The image processing apparatus according to claim 2,
wherein the processor is configured to adjust a tomographic range for generating the tomographic image based on an image of an object of interest included in the projection image, as the parameter.

8. The image processing apparatus according to claim 2,
wherein the processor is configured to output the generated tomographic images to an output destination corresponding to a type of the tomographic image.

9. The image processing apparatus according to claim 2,
wherein the processor is configured to, in a case in which a user's designation of the parameter is received, adjust the parameter based on the designation.

10. The image processing apparatus according to claim 9,
wherein the processor is configured to
display the projection image, and
receive the designation performed on the projection image.

11. An image processing method executed by at least one processor included in an image processing apparatus used for CT imaging in which a series of processes is performed including acquisition of a plurality of projection images using a photon-counting type radiation detector and execution of multi-reconstruction for generating tomographic images by reconstructing the plurality of projection images based on a predetermined parameter, the image processing method comprising:
acquiring the projection image; and
adjusting the parameter based on the acquired projection image.

12. A non-transitory computer-readable storage medium storing an image processing program for causing at least one processor included in an image processing apparatus used for CT imaging in which a series of processes is performed including acquisition of a plurality of projection images using a photon-counting type radiation detector and execution of multi-reconstruction for generating tomographic images by reconstructing the plurality of projection images based on a predetermined parameter, to execute:
acquiring the projection image; and
adjusting the parameter based on the acquired projection image.
